(19) United States
(12) Patent Application Publication
(10) Pub. No.: US 2016/0059390 A1
(43) Pub. Date: Mar. 3, 2016

(54) CONTROL DEVICE FOR RATCHET WRENCH

(71) Applicant: Yi-Fu Chen, Taichung City (TW)

(72) Inventor: Yi-Fu Chen, Taichung City (TW)

(21) Appl. No.: 14/469,591

(22) Filed: Aug. 27, 2014

(51) Int. Cl. B25B 13/46

(52) U.S. Cl. CPC B25B 13/465

(57) ABSTRACT

A ratchet wrench includes a handle having a hole in which a driving unit is located. A control member is partially engaged with the hole and connected to the top of the driving unit. The driving unit has a pawl engaged with the toothed face of the hole of the handle. A bead is movably received in the protrusion of the driving unit and cooperated with an operation rod. The operation rod is connected with a positioning unit located in the circular recess of the control member. The positioning member has a nut, a spring and a press disk. The nut is connected to the connection rod. A flange extends from the top of the nut. The spring is engaged between the flange and the press disk which is movable within the circular recess. A locking member extends through the press disk and is connected to the operation rod.

### BACKGROUND OF THE INVENTION

1. Fields of the Invention

The present invention relates to a control device, and more particularly, to a control device for a ratchet wrench and the control device is easily assembled.

2. Descriptions of Related Art

The conventional ratchet wrenches are used to be cooperated with a socket so as to tighten or loosen an object such as a nut or a bolt. The conventional ratchet wrenches have a ratchet device so as to allow the user to tighten or loosen an object without removing the wrench from the object. However, the ratchet device comprises many parts and some of which are small so that when assembling these parts into a limited space of the wrench, the assemblers have to concentrate and spend a lot of time.

A conventional wrench known to applicant discloses a control disk which is rotatably connected to the top of the driving member. The control disk has a circular recess and a stepped face is defined in the underside of the control disk. A groove is defined in the outside of the protrusion of the driving member and a clip is engaged with the groove. The clip partially protrudes from the outside of the protrusion. The clip is located above the stepped face, so that the control disk is restricted between the protrusion and the clip. By this way, the control disk is secured.

However, relationship of position between the clip and the coil spring is not stable. Although the coil spring is positioned by the operation rod, the coil spring tends to shift a small distance when it is compressed. Besides, the circular slot is so small so that the clip is difficult to be engaged with the groove. The clip sometimes even hits the control disk.

The present invention intends to provide a control device for a ratchet wrench, and the control device eliminates the shortcomings mentioned above.

### SUMMARY OF THE INVENTION

The present invention relates to a ratchet wrench and comprises a handle having a hole defined through one end thereof, and the hole has a toothed face defined in the inner periphery thereof. A driving unit has a driving member, a pawl, a heart-shaped spring and an operation rod. The driving member is located in the hole of the handle. A connection rod extends from the first end of the driving member and a protrusion extends from the second end of the driving member. The driving member has a first recess defined in the outside thereof. The pawl is located in the first recess and has teeth defined in the outside thereof. The teeth are engaged with the toothed face of the hole of the handle. A bead is engaged with the protrusion. The heart-shaped spring is mounted to the connection rod and has an insertion which is inserted into an insertion hole in the pawl. The operation rod is inserted into the protrusion of the driving member and extends through the connection rod. A notch is defined in the outside of the operation rod and the bead is engaged with the notch.

A control member is partially located in the hole of the handle and has a circular recess defined in the top thereof. An oval slot is defined through the inner end of the circular recess and the connection rod extends through the oval slot. The control member has a stud extending from the underside thereof and the stud extends through the heart-shaped spring and located at the tip end of the heart-shaped spring.

A positioning unit has a nut, a spring and a press disk. The nut is located in the circular recess of the control member and connected to the connection rod. An underside of the nut contacts the inner end of the circular recess. A flange extends from the top of the nut. The spring is engaged between the flange and the press disk. The press disk is movable within the circular recess. A locking member extends through the press disk and is connected to the operation rod.

Preferably, the notch of the operation rod comprises a first notch and a second notch. The depth of the first notch is deeper than that of the second notch. When the bead is engaged with the first notch, the bead is completely merged in the first notch. When the bead is engaged with the second notch, a portion of the bead protrudes from the protrusion.

Preferably, the control member and the stud are integrally formed with each other.

Preferably, the stud is connected to the control member individually.

Preferably, the area of the circular recess and the area of the nut are both larger than the area of the oval slot.

Preferably, the driving member has a second recess which is located diametrically to the first recess. The depth of the first recess is deeper than that of the second recess. The stud on the control member is movable in the second recess and drives the heart-shaped spring to pivot so as to control the engagement between the pawl and the toothed face of the hole.

The primary object of the present invention is to provide a ratchet wrench wherein the nut of the positioning unit is in contact with the inner end of the circular recess of the control member, and a flange extends from the top of the nut so that one end of the spring is mounted to the flange to easily position the spring and the nut. The ratchet wrench is easily assembled while the nut does not need to be connected with the oval slot.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the ratchet wrench of the present invention;

FIG. 2 is a cross sectional view to show that the press disk has not yet compressed the spring, and the bead partially protrudes from the protrusion of the driving unit, and

FIG. 3 is a cross sectional view to show that the press disk compresses the spring, and the bead is completely merged into the protrusion of the driving unit.

### DETAILED DESCRIPTION OF THE PREFERRED EMBODIMENT

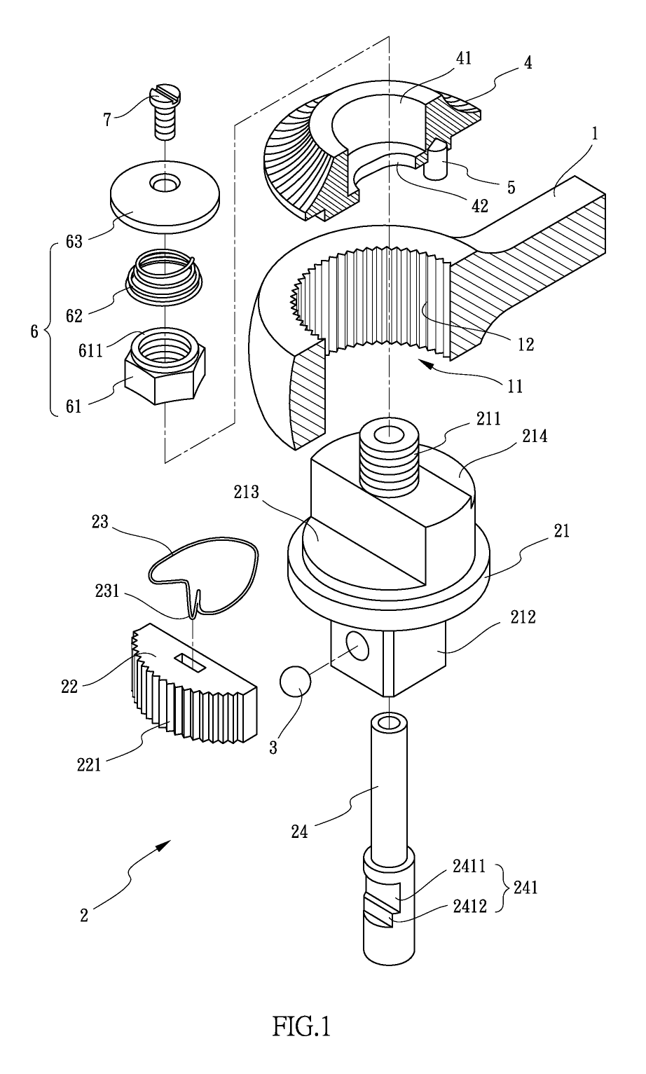

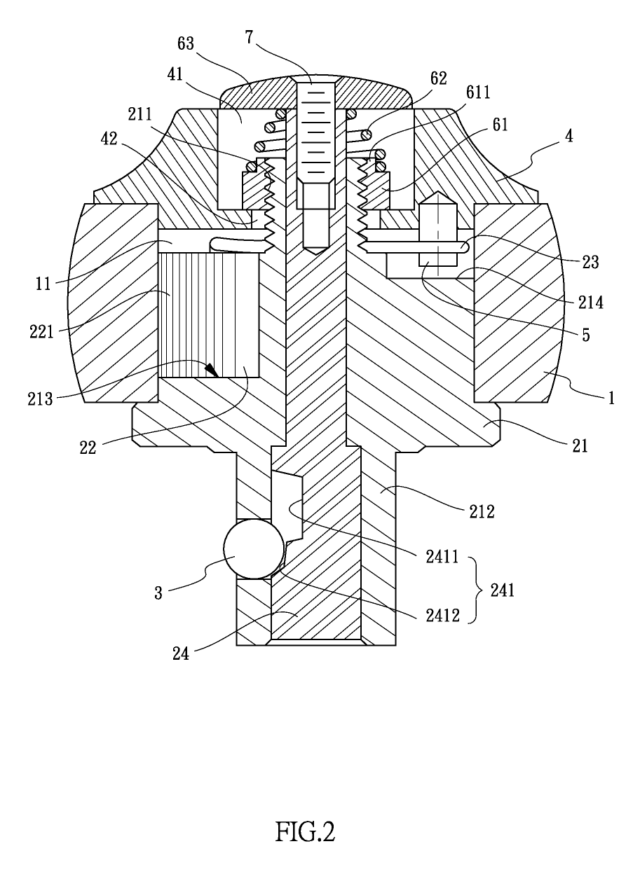

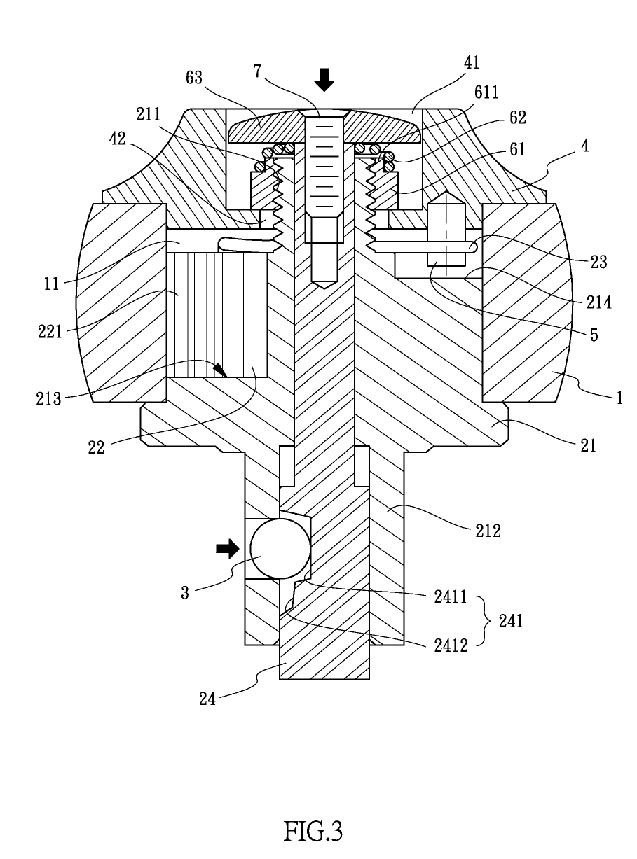

Referring to FIGS. 1 to 3, the ratchet wrench of the present invention comprises a handle 1 having a hole 11 defined through one end thereof, and the hole 11 has a toothed face 12 defined in the inner periphery thereof. A driving unit 2 comprises a driving member 21, a pawl 22, a heart-shaped spring 23 and an operation rod 24. The driving member 21 is located in the hole 11 of the handle 1. A connection rod 211 extends from the first end of the driving member 21 and a protrusion 212 extends from the second end of the driving member 21. The protrusion 212 is a polygonal protrusion so as to be connected with a socket (not shown). The driving member 21 is a cylindrical part and a first recess 213 is defined in the outside of the driving member 21. A passage is defined through the driving member 21, the protrusion 212 and the connection rod 211. The pawl 22 is located in the first recess 213 and has teeth 221 defined in the outside thereof. The teeth 221 are engaged with the toothed face 12 of the hole 11 of the handle 1. A bead 3 is movably engaged with a hole defined through the wall of the protrusion 212 and the hole communicates with the passage in the protrusion 212. The heart-shaped spring 23 has the first end mounted to the connection rod 211 and an insertion 231 extends from the first end of the heart-shaped spring 23 and is inserted into an insertion hole in the pawl 22. The second end of the heart-shaped spring 23 is a tip end 232. The operation rod 24 is inserted into the passage of the protrusion 212 of the driving member 21 and extends through the connection rod 211. A notch 241 is defined in the outside of the operation rod 24 and the bead 3 is engaged with the notch 241.

The notch 241 of the operation rod 24 comprises a first notch 2411 and a second notch 2412. The depth of the first notch 2411 is deeper than that of the second notch 2412. The width of the first notch 2411 is wider than that of the second notch 2412. The first and second notches 2411, 2412 are located adjacent to each other. When the bead 3 is engaged with the first notch 2411, the bead 3 is completely merged in the first notch 2411. When the bead 3 is engaged with the second notch 2412, a portion of the bead 3 protrudes from the protrusion 212.

A control member 4 is partially located in the hole 11 of the handle 1 and has a circular recess 41 defined in the top thereof. An oval slot 42 is defined through the inner end of the circular recess 41 and the connection rod 211 extends through the oval slot 42. The control member 4 has a stud 5 extending from the underside thereof. The stud 5 extends through the tip end 232 of the heart-shaped spring 23 and contacts the inside of the tip end 232.

A positioning unit 6 has a nut 61, a spring 62 and a press disk 63. The nut 61 is located in the circular recess 41 of the control member 4 and connected to the connection rod 211. The underside of the nut 61 contacts the inner end of the circular recess 41. A flange 611 extends from the top of the nut 61. The spring 62 has one end mounted to the flange 611 and the other end of the spring 62 contacts the press disk 63. The press disk 63 is movable within the circular recess 41. A locking member 7, such as a bolt, extends through the press disk 63 and is connected to the operation rod 24.

When assembling, the nut 61 is directly locked to the connection rod 211 until the nut 61 contacts the inner end of the circular slot 41. The nut 61 does not need to be engaged with the oval slot 42 to be positioned. The assembling steps become simple and convenient. The spring 62 is mounted to the flange 611 on the nut 61 can ensure that the spring 62 does not separate from the desired position. The area of the circular recess 41 and the area of the nut 61 are both larger than the area of the oval slot 42, so that the nut 61 firmly contacts against the inner end of the circular recess 41.

The socket that is connected to the protrusion 212 can be secured and removed by moving the operation rod 24. When the bead 3 is engaged with the first notch 2411, the bead 3 is completely merged in the first notch 2411 so that the socket can be easily removed from the protrusion 212. When the user presses the press disk 63 to compress the spring 62, the operation rod 24 is moved, and the bead 3 is removed from the second notch 2412 and engaged with the first notch 2411, the bead 3 is completely merged in the first notch 2411 so that the socket can be easily removed from the protrusion 212. On the contrary, when the bead 3 is engaged with the second notch 2412, a portion of the bead 3 is pushed by the inner end of the second notch 2412 and protrudes from the protrusion 212 so as to secure the socket on the protrusion 212.

The driving member 21 has a second recess 214 which is located diametrically to the first recess 213. The depth of the first recess 213 is deeper than that of the second recess 214. The stud 5 on the control member 4 is movable in the second recess 214 and drives the heart-shaped spring 23 to pivot so as to control an engagement between the pawl 22 and the toothed face 12 of the hole 11.

When rotating the control member 4 to shift the stud 5, the heart-shaped spring 23 is pivoted so as to control the engagement between the pawl 22 and the toothed face 12 of the hole 11. It is noted the control member 4 and the stud 5 are integrally formed with each other, or the stud 5 is inserted into a hole defined in the underside of the control member 4 individually. The second recess 214 of the driving member 21 allows the stud 5 to have sufficient space to move so as to pivot the heart-shaped spring 23. Because the depths of the first and second recesses 213, 214 are different so that the assembler can easily tell the correct position that the pawl 22 is to be installed.

While we have shown and described the embodiment in accordance with the present invention, it should be clear to those skilled in the art that further embodiments may be made without departing from the scope of the present invention.

What is claimed is:

1. A ratchet wrench comprising:
a handle having a hole defined through an end thereof, the hole having a toothed face defined in an inner periphery thereof;
a driving unit having a driving member, a pawl, a heart-shaped spring and an operation rod, the driving member located in the hole of the handle, a connection rod extending from a first end of the driving member and a protrusion extending from a second end of the driving member, the driving member having a first recess defined in an outside thereof, the pawl located in the first recess and having teeth defined in an outside thereof, the teeth engaged with the toothed face of the hole of the handle, a bead engaged with the protrusion, the heart-shaped spring mounted to the connection rod and having an insertion which is inserted into an insertion hole in the pawl, the operation rod inserted into the protrusion of the driving member and extending through the connection rod, a notch defined in an outside of the operation rod and the bead engaged with the notch;
a control member partially located in the hole of the handle and having a circular recess defined in a top thereof, an oval slot defined through an inner end of the circular recess and the connection rod extending through the oval slot, the control member having a stud extending from an underside thereof, the stud extending through the heart-shaped spring and located at a tip end of the heart-shaped spring, and
a positioning unit having a nut, a spring and a press disk, the nut located in the circular recess of the control member and connected to the connection rod, an underside of the nut contacting the inner end of the circular recess, a flange extending from a top of the nut, the spring engaged between the flange and the press disk, the press disk being movable within the circular recess, a locking member extending through the press disk and connected to the operation rod.

2. The ratchet wrench as claimed in claim 1, wherein the notch of the operation rod comprises a first notch and a second notch, a depth of the first notch is deeper than that of the second notch, when the bead is engaged with the first notch, the bead is completely merged in the first notch, when the bead is engaged with the second notch, a portion of the bead protrudes from the protrusion.

3. The ratchet wrench as claimed in claim 1, wherein the control member and the stud are integrally formed with each other.

4. The ratchet wrench as claimed in claim 1, wherein the stud is connected to the control member individually.

5. The ratchet wrench as claimed in claim 1, wherein an area of the circular recess and an area of the nut are both larger than an area of the oval slot.

6. The ratchet wrench as claimed in claim 1, wherein the driving member has a second recess which is located diametrically to the first recess, a depth of the first recess is deeper than that of the second recess, the stud on the control member is movable in the second recess and drives the heart-shaped spring to pivot so as to control an engagement between the pawl and the toothed face of the hole.
